(19) United States
(12) Patent Application Publication
(10) Pub. No.: US 2007/0223555 A1
(43) Pub. Date: Sep. 27, 2007

(54) Electrode for an inductive flow measuring device

(76) Inventors: Dieter Keese, Wahlsburg (DE); Wilfried Conrady, Dundenstadt (DE); Peter Scheede, Rosdorf (DE)

Correspondence Address: ABB Inc., Legal Dept. -4U6, 29801 Euclid Avenue, Wickliffe, OH, 44092-1832, US

(21) Appl. No.: 11/643,244

(22) Filed: Dec. 21, 2006

(30) Foreign Application Priority Data
Dec. 23, 2005 (DE) DE 102005062102.3
Feb. 4, 2006 (DE) DE 102006005116.5

(51) Int. Cl. H05B 7/14

(52) U.S. Cl. 373/92

(57) ABSTRACT

The invention relates to an electrode for a flow measuring device according to the preamble of patent claim 1. In order to obtain an electrode which is easy to assemble, according to the invention the electrode consists of at least two elements which are connected together via a threaded bush or a nut, and the two parts are kept apart by mechanical spring tension via two spring elements lying between them.

### CROSS REFERENCE TO RELATED APPLICATIONS

This application claims priority from German Application Nos. DE 10 2005 062 102.3 filed on Dec. 23, 2005 and DE 10 2006 005 116.5 filed on Feb. 4, 2006 the contents of which are relied upon and incorporated herein by reference in their entirety, and the benefit of priority under 35 U.S.C. 119 is hereby claimed.

### BACKGROUND OF THE INVENTION

The invention relates as an example to the known measurement principle which is employed in magnetic inductive flow meters (IFMs).

The physical effect utilized for measuring the flow rate is Faraday's law of induction.

If an electrically conductive substance to be measured is passed through a magnetic field B, then an electric field E is set up in the substance to be measured perpendicularly to the flow direction v and to the magnetic field direction.
E=B*v

The flow signal formed is measured by electrodes in contact with the substance to be measured. To this end, one-piece or multi-part electrodes are known for flow measuring instruments. Apart from the desired suitability even for abrasive media, corresponding materials may be used. However, secure seating of the electrodes is also important in this case.

### SUMMARY OF THE INVENTION

It is therefore an object of the invention to provide an improved electrode of the species so as on the one hand to provide an electrode which is applicable in respect of its chemical resistance properties, but on the other hand so that secure seating of such a usually multi-part electrode is also ensured.

The invention is directed to an electrode that consists of at least two elements which are connected together via a threaded bush or a nut, and the two parts are kept apart by mechanical spring tension via two spring elements lying between them. This provides secure mechanical and tight seating, and on the other hand the electrode is segmented in such a way that only the surfaces which come in contact with the substance to be measured consist of a noble material or need to be coated. The rest of the components may consist of inexpensive materials. This is a further effect.

Furthermore, an advantageous configuration is that the springs are disk springs.

In a further advantageous configuration, at least one washer for spacing definition is also incorporated.

It is advantageous that a retaining film may be arranged in co-alignment at least on one side in the overall arrangement

According to a last advantageous configuration, the upper part of the electrode is a rod- or cup-shaped element with solder lugs fitted in it. In this way, the electrode can be assembled easily and installed expediently.

The electrodes are sealed into the plastic-clad measurement tubes by means of spring elements. Usually, a number of disk springs are stacked along the electrode shaft and compressed by a fastening element, for example a nut or clamping disk.

### BRIEF DESCRIPTION OF THE DRAWINGS

Two exemplary embodiments are represented in the drawings and described below.

FIG. 1 shows an electrode with a threaded bush

FIG. 2 shows an electrode with a threaded rod

### DETAILED DESCRIPTION OF ILLUSTRATIVE EMBODIMENTS

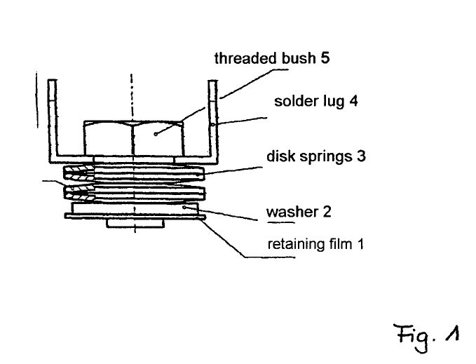

FIG. 1 shows the electrode in the assembled form. The electrode, or the electrically active surface, lies below i.e. on the opposite side from the solder lug 4, where it may be provided with a rounded electrode disk (not further represented here).

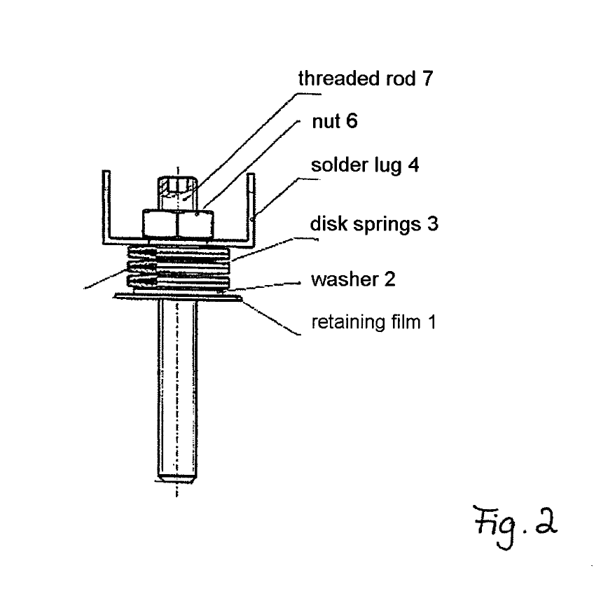

FIG. 2 shows the structure in detail. A washer 2 is arranged on a retaining film 1. A stack of a plurality of disk springs 3 lies thereon. A solder lug for the electrical connection is in turn arranged thereon. All the individual parts are held by a threaded rod, which extends through all the individual components. At the upper end, the entire stack and the components are held under tension by means of a screwed-on nut 6 or a threaded bush 5.

The invention thus relates to an inexpensive alternative for electrodes which are made in two parts, namely that the electrode part not in contact with the substance to be measured, i.e. the electrode shaft, is made from a commercially available threaded rod. Before assembling the electrodes in a measurement tube, the requisite spring elements, for example disk springs, and the fastening element used to tension the springs, for example a nut, are fitted on this threaded rod which is responsible for electrical contacting and fastening the electrodes in the measurement tube. The individual parts are fixed on the threaded rod by a thin film, so as to prevent inadvertent release of the individual elements from the threaded rod when assembling the electrodes.

A further advantage of the concept is to configure the threaded rod with an outer or inner hexagon or any other shape such that when assembling, i.e. installing the electrode in the measurement tube, simple and inexpensive fastening of the two parts can be achieved. At the same time, co-rotation of the electrode is prevented with the aid of these mechanical connections when tensioning the spring elements to keep the electrodes sealed, for example by using a nut, so that the requisite spring force can be adjusted with a torque wrench. The advantages described above are also advantageous in the case of connecting elements, for example short electrodes which are installed in the measurement tube with an extension piece.

With the described design, it is possible to reduce assembly costs and increase the quality of the sealed connection of the electrode to the measurement tube, with definable and reproducible tensioning of the spring elements to adjust the sealing force.

1. An electrode for an inductive flow measuring device, which is applied through the wall of the measurement tube, wherein the electrode consists of at least two elements which are connected together via a threaded bush or a nut, and the two parts are kept apart by mechanical spring tension via two spring elements lying between them.

2. The electrode as claimed in claim 1, wherein the springs are disk springs.

3. The electrode as claimed in claim 1 or 2, wherein at least one washer for spacing definition is also incorporated.

4. The electrode as claimed in one of the preceding claims, wherein a retaining film is arranged in co-alignment at least on one side in the overall arrangement.

5. The electrode as claimed in one of the preceding claims, wherein the upper part of the electrode is a rod- or cup-shaped element with solder lugs fitted in it.
